(19) United States
(12) Patent Application Publication
(10) Pub. No.: US 2022/0257042 A1
(43) Pub. Date: Aug. 18, 2022

(54) Christmas Tree Foot Water Replenisher

(71) Applicant: NINGBO FLYING-HORSE INTERNATIONAL TRADE CO., LTD, Ningbo (CN)

(72) Inventor: Honghua Zhao, Ningbo (CN)

(73) Assignee: NINGBO FLYING-HORSE INTERNATIONAL TRADE CO., LTD, Ningbo (CN)

(21) Appl. No.: 17/739,221

(22) Filed: May 9, 2022

(30) Foreign Application Priority Data
Jan. 28, 2022 (CN) 202220243652.8

(51) Int. Cl. A47G 33/12

(52) U.S. Cl. CPC A47G 33/12; A47G 2033/122; A47G 2033/1293

(57) ABSTRACT

A Christmas tree foot water replenisher is disclosed in the present invention, including a water supply assembly and a water discharge control assembly, the water supply assembly includes a water pump and a water pipe, and the water discharge control assembly includes a first float switch and a third float switch. The first float switch is arranged in a water storage chamber to detect a liquid level, the third float switch is arranged in a cylinder cavity to detect a liquid level, and the water pump, the first float switch, and the third float switch are electrically connected in series. The water replenisher of the present invention automatically replenishes water according to the liquid level height in the cylinder cavity, and can stop the water pump when the liquid level in the water storage chamber is too low.

### TECHNICAL FIELD

The present invention belongs to the field of festival decoration devices, and in particular, relates to a water replenisher that can automatically replenish water to a Christmas tree foot.

### BACKGROUND

Christmas is a traditional festival in European and American countries. When Christmas comes, people like to make festival decorations through Christmas trees.

Christmas trees are currently classified into real trees and fake trees. For the real trees, fir and other tree species are used as Christmas trees. In order to keep the vitality of a Christmas tree, it is generally necessary to place the bottom of a base trunk in water or add water regularly.

The existing Christmas tree foot only has a fixing function but do not have the function of adding water. Even for some tree feet with good sealing performance of cylinders, they can store water but cannot automatically replenish water.

Therefore, it is necessary to develop an automatic water replenisher that can automatically replenish water into a cylinder cavity of a Christmas tree foot according to set requirements to keep the vitality of a real Christmas tree (referred to as a real tree for short).

### SUMMARY

An objective of the present invention is to provide a Christmas tree foot water replenisher with an automatic water replenishing function.

For achieving the above objective, a solution adopted in the present invention is:

A Christmas tree foot water replenisher, including: a water supply assembly, wherein the water supply assembly includes a water pump and a water pipe, one end of the water pipe is connected to the water pump, and the other end is formed as a water outlet to inject water into a cylinder cavity of the tree foot.

The Christmas tree foot water replenisher further includes a water discharge control assembly, wherein the water discharge control assembly includes a first float switch and a third float switch; the first float switch is arranged in a water storage chamber to detect a liquid level height in the water storage chamber, and the first float switch is turned on when the liquid level is higher than a first preset liquid level, and is turned off when the liquid level is lower than the first preset liquid level; the third float switch is arranged in the cylinder cavity to detect a liquid level height in the cylinder cavity, and the third float switch is turned off when the liquid level of the cylinder cavity is higher than a third preset liquid level, and is turned on when the liquid level is lower than the third preset liquid level. The water pump, the first float switch, and the third float switch are electrically connected in series.

According to the above Christmas tree foot water replenisher, the water discharge control assembly further includes a second float switch, which is arranged in the water storage chamber to detect the liquid level height in the water storage chamber, and the first float switch is turned off or turned on when the liquid level is higher than a second preset liquid level, and turned on or off when the liquid level is lower than the second preset liquid level; and the second float switch is electrically connected in series to a water level warning light.

According to the above Christmas tree foot water replenisher, the second preset liquid level is higher than the first preset liquid level, so that the water level warning light is turned on or off as a warning before the water pump stops working.

According to the above Christmas tree foot water replenisher, the first float switch is arranged on a bottom surface of the water storage chamber, the second float switch is arranged on a boss, and the boss is arranged to protrude from the bottom surface of the water storage chamber, so that the second float switch is arranged higher than the first float switch.

According to the above Christmas tree foot water replenisher, the water supply assembly further includes a water tank assembly, the water tank assembly includes a water tank main body, the water storage chamber is arranged in the water tank main body, and a cover body further fits the water tank main body.

According to the above Christmas tree foot water replenisher, the cover body is provided with a buckle groove for buckled with a top wall of the water storage chamber, and a sinking surface arranged downward with respect to the buckle groove, the sinking surface is arranged lower than the buckle groove, and the sinking surface is further provided with an upper hole.

According to the above Christmas tree foot water replenisher, the bottom surface of the water storage chamber is further provided with a precipitation area arranged concavely, and the precipitation area is arranged lower than the bottom surface of the water storage chamber.

According to the above Christmas tree foot water replenisher, a device cavity is arranged under the bottom surface of the water storage chamber, and the water pump and a power supply assembly are arranged in the device cavity.

According to the above Christmas tree foot water replenisher, a motor seat is further arranged in the device cavity, and a motor fixing member is arranged on the side of the motor seat.

According to the above Christmas tree foot water replenisher, a bottom cover fits the device cavity, and a motor pressing block is arranged on the bottom cover.

According to the above Christmas tree foot water replenisher, the water discharge control assembly further includes a clamp fitted. on the tree foot, and the third float switch is connected to the clamp to be located in a vertical position in the cylinder cavity.

According to the above Christmas tree foot water replenisher, the water discharge control assembly further includes a protective cover, the third float switch is arranged in the protective cover, and the protective cover has a cover wall to protect displacement of a floating ball of the third float switch to prevent its floating from interference.

According to the above Christmas tree foot water replenisher, the protective cover is formed by fitting two symmetrically arranged protective cover shells, and the interior of the protective cover is hollow to form a float switch cavity for the third float switch to be arranged.

According to the above Christmas tree foot water replenisher, the water pipe is sleeved by a wire receiving tube, the wire receiving tube is connected to the protective cover, and a wire of the third float switch is arranged along an outer surface of the water pipe and is received by the wire receiving tube.

According to the above Christmas tree foot water replenisher, the clamp includes a clamp opening for fitting the wire receiving tube, and a first fixing member and/or second fixing member for connecting the clamp to the tree foot. The first fixing member includes two clamp pieces arranged opposite to each other, so as to be clamped on a wall of the tree foot; and the second fixing member is used for fitting on a fastener of the tree foot, and includes a fixed abutting block and a movable adjusting pin rotatably arranged with respect to the fixed abutting block.

The water replenisher of the present invention has the following advantages:

1. It can realize automatic water replenishment. When the liquid level of the cylinder cavity of the tree foot is lower than a preset standard, the water pump will automatically start to replenish water; after the liquid level reaches the preset standard, it may also automatically stop; and so on and so forth.

2. The structure is simple, easy to manufacture and use, and can be powered by a dry battery.

3. In addition to an automatic stop function in case of water shortage, a water shortage forecast function is further provided, which can issue a warning of insufficient quantity in advance before the water pump stops working.

4. The water outlet and protective cover are easy to install. By clamping the clamp on the side wall of the cylinder cavity or the fastener, the purpose of fixing it can be easily achieved, and the position of the third float switch in the cylinder cavity, that is, the height of the liquid level it controls, can also be easily adjusted.

5. There is also a precipitation area in the water tank to precipitate impurities and prevent the water inlet from being blocked.

6. The water pipe and the third float switch are connected together by the wire receiving tube to fatm the integration of the outlet and water level detection.

7. The device cavity further includes positioning and pressing functions for the motor, which can prevent winding of the water pipe or wire due to the displacement or rotation of the motor during use or transportation from affecting the work of the pump.

### BRIEF DESCRIPTION OF THE DRAWINGS

FIG. 1 is a schematic structural diagram of a water replenisher according to a certain embodiment of the present invention;

FIG. 2 is a schematic structural exploded diagram of the embodiment of FIG. 1, where a schematic structural exploded diagram of a water tank assembly is shown;

FIG. 3 is a schematic structural diagram of the interior of a water tank in the embodiment of FIG. 1;

FIG. 4 is a schematic structural diagram of the bottom of a water tank in the embodiment of FIG. 1, where a bottom cover is not shown;

FIG. 5 is a schematic structural diagram of a water discharge control assembly in the embodiment of FIG. 1;

FIG. 6 is a structural exploded diagram of the water discharge control assembly of FIG. 5;

FIG. 7 is a schematic circuit diagram of the embodiment of FIG. 1;

FIG. 8 is a schematic structural diagram of a clamp in the embodiment of FIG. 1;

FIG. 9 is schematic structural diagram of State 1 when the clamp of FIG. 8 is fitted to the Christmas tree foot and a schematic partial enlarged diagram thereof;

FIG. 10 is schematic structural diagram of State 2 when the clamp of FIG. 8 is fitted to the Christmas tree foot and a schematic partial enlarged diagram thereof;

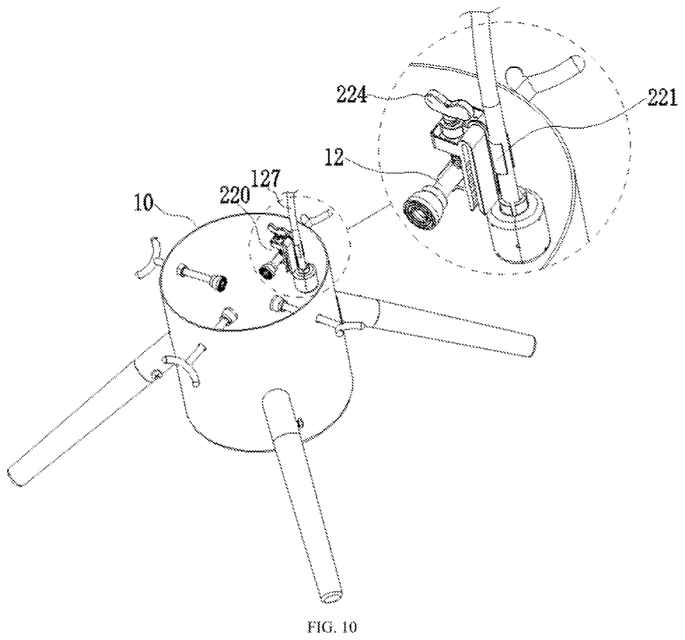

FIG. 11 is a schematic structural diagram of a device structure of the water tank assembly in the embodiment of FIG. 1; and

FIG. 12 is a schematic structural diagram of a bottom cover in the embodiment of FIG. 1.

Corresponding reference numerals are as follows:

Tree foot 10, Cylinder wall 11, Fastener 12, Cylinder cavity 13, Water tank assembly 100, Cover body 101, Upper hole 102, Hole cover 103, Water storage chamber 104. Water storage chamber top wall 1041, Sinking surface 1011, Buckle groove 1012, Water tank main body 110, Water storage chamber bottom surface 120, Boss 121, Precipitation area 122, First float switch 123, Second float switch 124, Water pump 125, Power supply assembly 126, Water pipe 127, Water storage chamber 104, Protective cover 200, Through hole 201, Connection port 202, Valve seat 203, Protective cover shell 204, Third float switch 205, First valve seat member 2031, Second valve seat member 2032, Clamp 220, Clamp opening 221, First fixing member 222, Fixed abutting block 223, Movable adjusting pin 224, Second fixing member 225, Pin seat 226.

### DESCRIPTION OF THE EMBODIMENTS

In order for those skilled in the art to better understand the present invention and thus to more clearly define the protection scope of the present invention, the present invention will be described in detail below with respect to some specific embodiments of the present invention. it should be noted that the following are only some specific embodiments of the present invention, which are only a part of the embodiments of the present invention, and the specific and direct description of the relevant structures is only for the convenience of understanding the present invention, and specific features do not definitely and directly limit the implementation scope of the present invention. Routine selections and substitutions made by those skilled in the art under the guidance of the concept of the present invention should all be deemed to be within the protection scope of the present invention.

A Christmas tree foot water replenisher includes a water supply assembly, the water supply assembly includes a water pump 125 and a water pipe 127, one end of the water pipe 127 is connected to the water pump 125, and the other end is formed as a water outlet to inject water into a cylinder cavity 13 of the tree foot.

The Christmas tree foot water replenisher further includes a water discharge control assembly, and the water discharge control assembly includes a first float switch 123 and a third float switch 205. The first float switch 123 is arranged in a water storage chamber 104 to detect a liquid level height in the water storage chamber 104. The first float switch 123 is turned on when the liquid level is higher than a first preset liquid level, and turned off when the liquid level is lower than the first preset liquid level. The third float switch 205 is arranged in the cylinder cavity 13, the third float switch is turned off when a liquid level in the cylinder cavity is higher than a third preset liquid level, and turned on when the liquid level is lower than the third preset liquid level. In addition, the water pump 125, the first float switch 123, and the third float switch 205 are electrically connected in series.

More preferably, the water discharge control assembly further includes a second float switch 124, which is arranged in the water storage chamber 104 to detect the liquid level in the water storage chamber 104. The first float switch 123 is turned off when the liquid level is higher than a second preset liquid level, and turned on when the liquid level is lower than the second preset liquid level. Moreover, the second float switch 124 is electrically connected in series to a water level warning tight.

Preferably, the second preset liquid level is higher than the first preset liquid level, so that the water level warning tight is turned on as a warning before the water pump stops working.

### Embodiment I

A Christmas tree foot water replenisher is used for automatically replenishing water in a real tree foot so that the amount of water in the tree foot is appropriate.

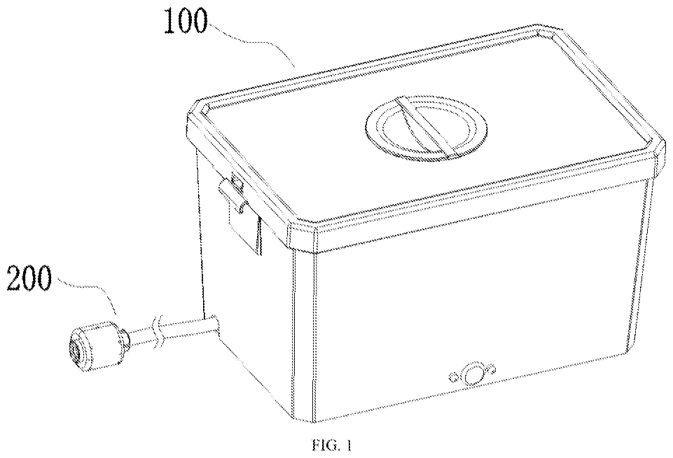

As shown in FIG. 1, a Christmas tree foot water replenisher is composed of a water tank assembly 100, a water pipe 127, and a water discharge control assembly. The water tank assembly 100 and the water pipe 127 form a water supply assembly, which is used for supplying water to a cylinder cavity 13 of the tree foot when required.

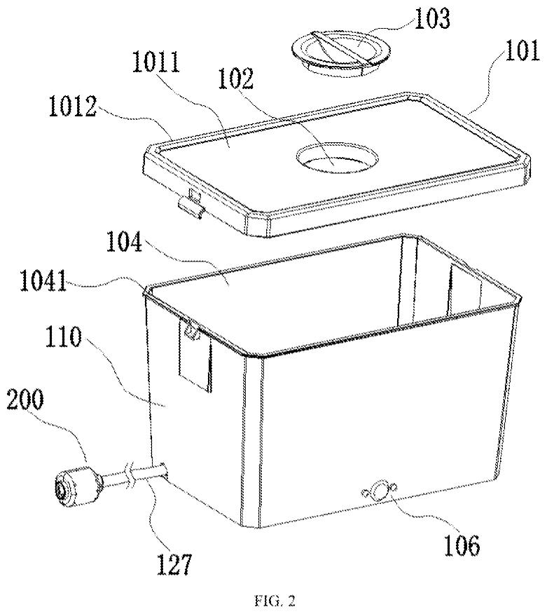

As shown in FIG. 2, the water tank assembly 100 includes a water tank main body 110. The water tank main body 110 is provided with a water storage chamber 104. A cover body 101 fits the water tank main body 110. The cover body 101 is provided with an upper hole 102, and a hole cover 103 is arranged at the upper hole 102. The cover body 101 is fastened to the water tank main body 110, and the upper hole 102 is used for replenishing water into the water storage chamber 104 or for observing the water level or water state in the water storage chamber 104.

The cover body 101 is provided with a buckle groove 1012 for buckled with a water storage chamber top wall 1041, and a sinking surface 1011 arranged downward with respect to the buckle groove 1012. The sinking surface 1011 is arranged lower than the buckle groove 1012, the upper hole 102 is arranged on the sinking surface 1011, so that when water is added to the water storage chamber 104 from the upper hole 102, the water will not overflow from the periphery, but is preferentially accumulated on the sinking surface 1011.

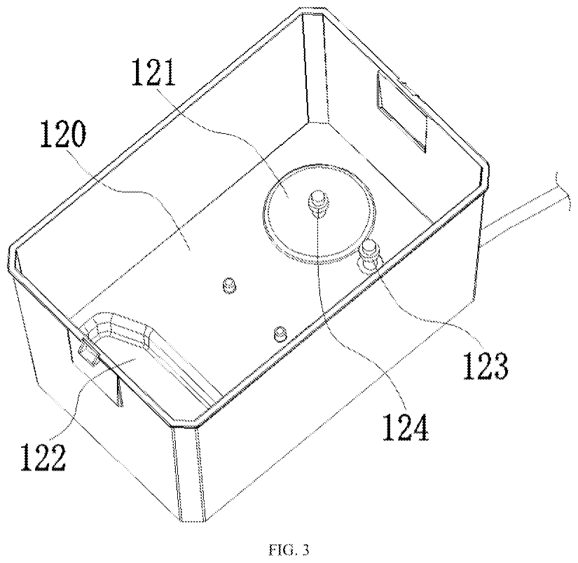

As shown in FIG. 3, the water storage chamber 104 has a water storage chamber bottom surface 120, and the water storage chamber bottom surface 120 has a substantially flat surface. The water storage chamber bottom surface 120 is further provided with a precipitation area 122 arranged concavely, and a boss 121 arranged in a protruding manner. The precipitation area is arranged lower than the water storage chamber bottom surface 120, so that impurities in the water are sedimented and then collected in the precipitation area 122, so as to avoid being added to the tree foot to damage the water pump or affect the survival of the real tree.

The boss 121 is arranged higher than the water storage chamber bottom surface 120, the boss 121 is provided with a second float switch 124, and the water storage chamber bottom surface 120 is further provided with a first float switch 123. The first float switch 123 is arranged in the water storage chamber 104 to detect a liquid level in the water storage chamber 104, and is turned on when the liquid level is higher than a first prearranged liquid level, and turned off when the liquid level is lower than the first prearranged liquid level. The second float switch 124 is arranged in the water storage chamber 104 to detect the liquid level in the water storage chamber 104, and is turned off when the liquid level is higher than a second prearranged liquid level, and turned on when the liquid level is lower than the second prearranged liquid level.

Moreover, the second float switch 124 is electrically connected in series to a water level warning light.

The boss 121 is arranged to protrude from the water storage chamber bottom surface 120; therefore, when float switches of the same or similar specifications are used, this will cause the second float switch 124 to detect reduction of the liquid level before. the first float switch 121 The second float switch 124 is used as a water level detection valve, and is connected to the water level warning light. The first float switch 123 is used as a water pump working valve, which is used for controlling the water pump to work normally or to stop working. Therefore, the second prearranged liquid level is higher than the first prearranged liquid level, so that the water level warning light is turned on as a warning before the water pump stops working.

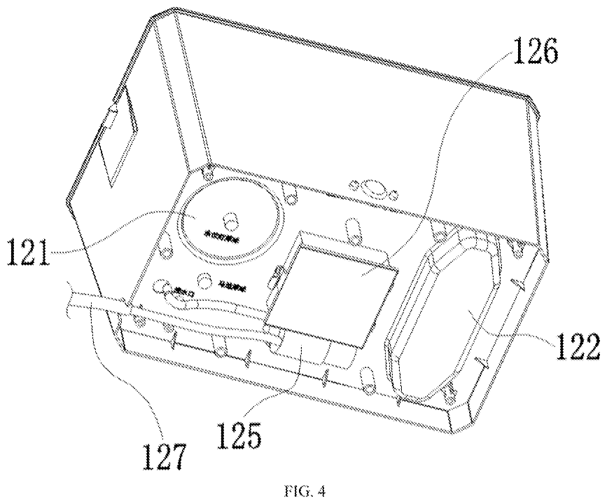

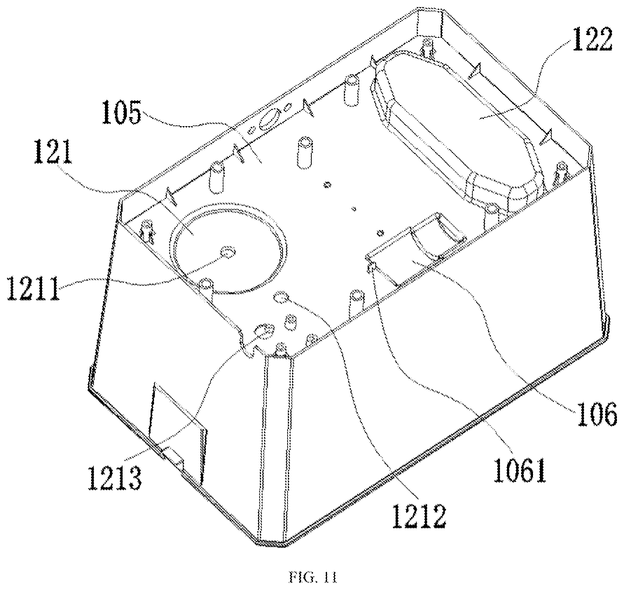

As shown in FIG. 4 and FIG. 11, the water storage chamber bottom surface 120 is at an appropriate distance from the bottom of the water tank main body 110, so that a hollow cavity is formed under the water storage chamber bottom surface 120 to serve as a device cavity 105. The device cavity is provided with the water pump 125 and a power supply assembly 126. A water inlet of the water pump 125 is in communication with a water pump inlet 1213 arranged on the water storage chamber bottom surface 120, and the water outlet of the water pump 125 is in communication with a first end of the water pipe 127.

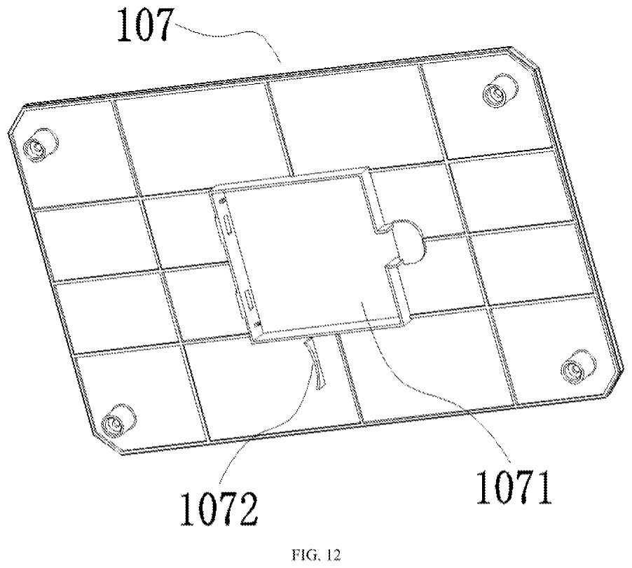

As shown in FIG. 11 and FIG. 12, the boss 121 is provided with a second floating ball hole 1211, and the water storage chamber bottom surface 120 is provided with a first floating ball hole 1212. The device cavity 105 is further provided with a motor seat 106, and a motor fixing member 1061 is arranged on one side of the motor seat 106. The motor fixing member 1061 is fitted between a water inlet and a water outlet of the motor, so as to prevent the motor from rotating in the motor seat 106 during transportation to cause winding of the water inlet and outlet pipes or the wire, which affects the operation of the motor. A bottom cover 107 fits the device cavity 105, and the bottom cover 107 is provided with a motor pressing block 1072 for fitting the motor seat 106 to compress the motor. In addition, the bottom cover 107 is further provided with a battery compartment opening 1071 for a battery compartment cover to fit.

In this embodiment, the power supply assembly 126 is a dry battery, so as to supply power through the dry battery. Of course, it is also feasible to replace it with a rechargeable battery or a power interface for connecting to an external power source.

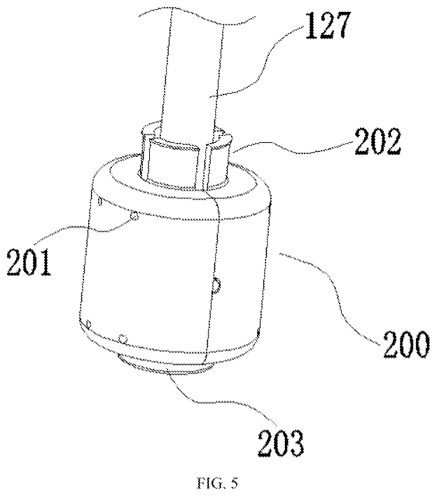

As shown in FIG. 5, the protective cover 200 is connected to a second end of the water pipe 127 to inject water pumped by the water pump into the tree foot. A valve seat 203 is formed at a lower end of the protective cover 200, and an upper end of the protective cover 200 is formed as a connection port 202. A plurality of through holes 201 are arranged on a main body of the protective cover 200 to communicate an internal cavity of the protective cover 200 and the exterior. The third float switch 205 is arranged in the protective cover, and the protective cover has a cover wall to protect displacement of a floating ball of the third float switch 205 to prevent its floating from interference.

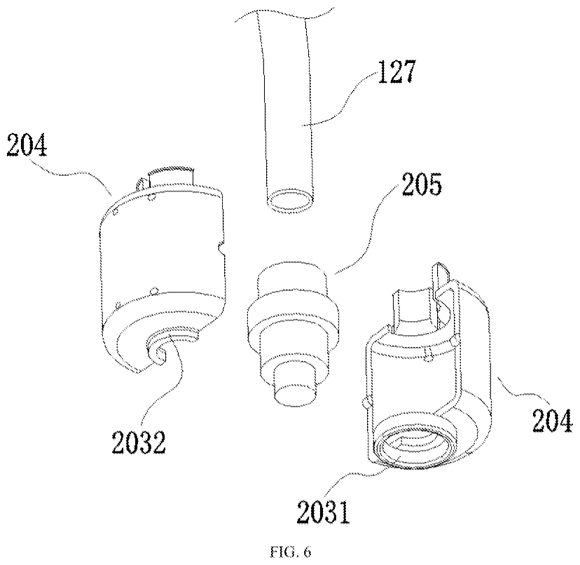

As shown in FIG. 6, the protective cover 200 is formed by fitting two symmetrically arranged protective cover shells 204. The protective cover 200 is hollow inside to form a protective cover inner cavity, and the third float switch 205 is arranged in the protective cover inner cavity. The third float switch 205 is arranged in the cylinder cavity 13, and is turned off when a liquid level in the cylinder cavity is higher than a third prearranged liquid level, and turned on when the liquid level is lower than the third prearranged liquid level.

In addition, the water pump 125, the first float switch 123, and the third float switch 205 are electrically connected in series.

In this embodiment, the third float switch 205 is fixed at the valve seat 203 at the bottom of the protective cover 200 to be vertically arranged in the inner cavity of the protective cover.

As shown in FIG. 6, the valve seat 203 includes a first valve seat member 2031 and a second valve seat member 2032, and the second valve seat member 2032 is a semicircular ring that is arranged to protrude from the bottom surface of the protective cover 200. The first valve seat member 2031 is an annular member, and its inner diameter is greater than or equal to the outer diameter of the second valve seat member 2032, so that the second valve seat member 2032 is inserted into the first valve seat member 2031 and the two protective cover shells 204 are snapped to each other for fixing. The lower end of the third float switch 205 is fitted between the first valve seat member 2031 and the second valve seat member 2032 to be fixed between the two protective cover shells 204.

In this embodiment, the water pipe 127 is further sleeved by a wire receiving tube (also referred to as a wire wrap tube and a wire management tube). The shape of the wire receiving tube is not limited. The wire receiving tube is connected to the protective cover 200. The wire of the third float switch 205 is arranged along an outer surface of the water pipe 127 and received by the wire receiving tube, so as to enter the device cavity and be electrically connected to the water pump or a water pump controller.

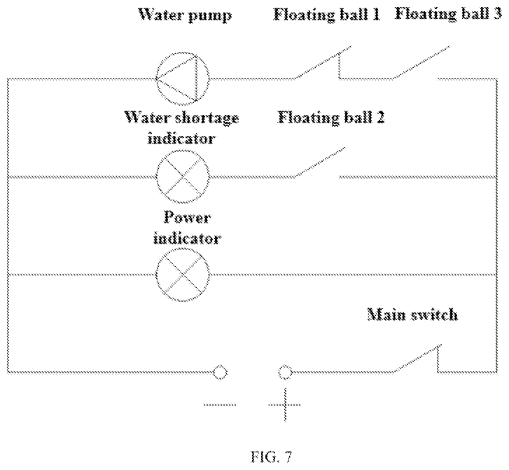

The circuit schematic diagram of the water replenisher of this embodiment is shown in FIG. 7. A power indicator is connected between positive and negative poles of the power supply to display a battery level. The second float switch 124 is a normally on float switch, which is connected to a water shortage indicator in series and then connected between the positive and negative poles of the power supply, The first float switch 123 is a normally on float switch, and the third float switch 205 is a normally off float switch. The first float switch 123, the third float switch 205, and the water pump are connected in series and then connected between the positive and negative poles of the power supply. In addition, a main switch is further provided in the circuit. A floating ball 1 is the first float switch 123, a floating ball 2 is the second float switch 124, and a floating ball 3 is the third float switch 205. For the normally on float switch, when the water level is not higher than (not in contact with) the floating ball, the switch is turned off. For the normally off float switch, when the water level is not higher than (not in contact with) the floating ball, the switch is turned off.

After the main switch is closed, the power indicator is turned on when the battery is fully charged, and is turned off when the battery is short of power. When the water level in the water tank drops below a detection height of the second float switch 124, the second float switch 124 is turned on, and the water shortage indicator is turned on. When the water level in the water tank further drops to the detection height of the first float switch 123, the first float switch 123 is turned off, and the water pump 125 stops working.

When the water volume in the water tank is sufficient and the water level is high, the second float switch 124 is turned off, the water shortage indicator is not turned on, the first float switch 123 is turned on, and the third float switch 205 is located in the protective cover 200. When the liquid level in the tree foot reaches the position of the third float switch 205, the third float switch 205 is turned off, and when the liquid level drops below the position of the third float switch 205, the third float switch 205 is turned on. Therefore, when the water volume in the water tank is sufficient and the first float switch 123 is closed, on and off of the water pump can be controlled by the third float switch 205 to achieve the purpose of automatic water replenishment. When the water level in the water tank drops below the minimum water level request, the first float switch 123 is turned off. At this time, the water pump does not work no matter whether the third float switch 205 is turned off or turned on.

In this embodiment, the position of the protective cover 200 in the tree foot 10 is related to the control level of the water replenisher for the liquid level.

Therefore, this embodiment further has a clamp 220 for fixing the water pipe 127 to adjust the position of the protective cover 200 in the tree foot, and the third float switch 205 is connected to the clamp 220 to locate its vertical position in the cylinder cavity 13, so as to achieve the purpose of controlling the liquid level height.

In this embodiment, the clamp 220 is provided with a clamp opening 221 for clamping the water pipe 127, and a first fixing member 222 and a second fixing member 225 for fixing the clamp 220 to the tree foot 10. The inner diameter of the clamp opening 221 is smaller than the outer diameter of the water pipe 127, so as to clamp and fix the water pipe 127 therein. The clamp opening 221 is provided with an opening for the water pipe 127 to fit in or release from.

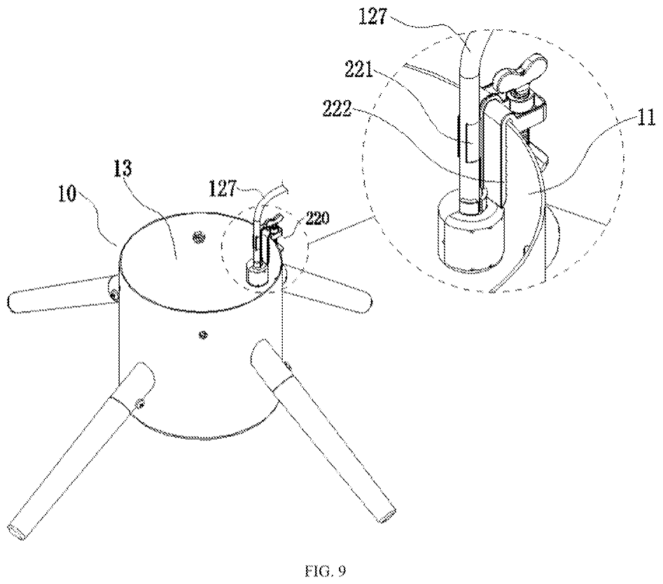

The first fixing member 222 is composed of two clamp pieces arranged opposite to each other, which are used for clamping a cylinder wall 11 of the tree foot 10 to form a fitting state as shown in FIG. 9.

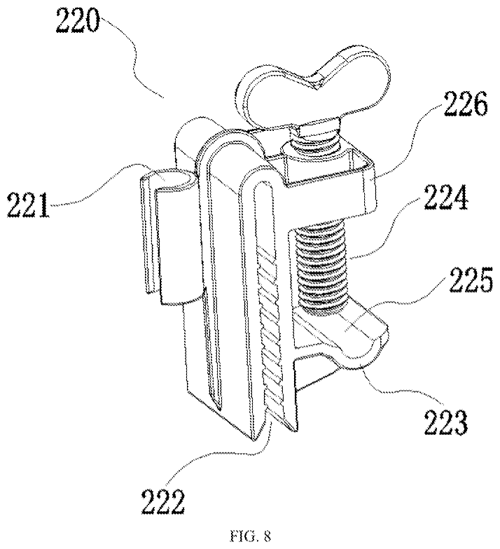

The second fixing member 225 is used for fitting on a fastener 12 of the tree foot 10, and is formed by fitting a fixed abutting block 223 and a movable adjusting pin 224. The clamp 220 is provided with a pin seat 226 arranged corresponding to the fixed abutting block 223 at an interval. The pin seat 226 is provided with a pin hole. An inner wall of the pin hole and an outer wall of the adjusting pin 224 are respectively provided with internal threads and external threads that fit each other, so that the adjusting pin 224 can be rotatably arranged on the pin seat 226. As shown in FIG. 8, a rear end of the adjusting pin 224 is further provided with a handle to facilitate rotation of the adjusting pin 224. A front end of the adjusting pin 224 approaches or moves away from the fixed abutting block 223 so as to adjust the size and fitting state of the second fixing member 225.

A specific manner for the clamp 220 in this embodiment to be fixed to the tree base 10 can be selected according to needs, which is not limited. In addition, the clamp opening 221 and the water pipe 127 are in an interference fit, and therefore, after the clamp 220 is fixed, the position of the protective cover 200 in the tree foot, that is, the depth of the protective cover 200 extending into the inner cavity of the tree foot, may also be adjusted as required, thereby adjusting the liquid level in the tree foot.

What is claimed is:

1. A Christmas tree foot water replenisher, comprising:
a water supply assembly, wherein the water supply assembly comprises a water pump and a water pipe, one end of the water pipe is connected to the water pump, and the other end is formed as a water outlet to inject water into a cylinder cavity of the tree foot;
a water discharge control assembly, wherein the water discharge control assembly comprises a first float switch and a third float switch; the first float switch is arranged in a water storage chamber to detect a liquid level in the water storage chamber, and the first float switch is turned on when the liquid level is higher than a first preset liquid level, and is turned off when the liquid level is lower than the first preset liquid level; the third float switch is arranged in the cylinder cavity, and the third float switch is turned off when a liquid level of the cylinder cavity is higher than a third preset liquid level, and is turned on when the liquid level is lower than the third preset liquid level; and
the water pump, the first float switch, and the third float switch are electrically connected in series.

2. The Christmas tree foot water replenisher according to claim 1, wherein the water discharge control assembly further comprises a second float switch, which is arranged in the water storage chamber to detect the liquid level in the water storage chamber, and the first float switch is turned off or turned on when the liquid level is higher than a second preset liquid level, and turned on or off when the liquid level is lower than the second preset liquid level; and the second float switch is electrically connected in series to a water level warning light.

3. The Christmas tree foot water replenisher according to claim 2, wherein the second preset liquid level is higher than the first preset liquid level, so that the water level warning light is turned on or off as a warning before the water pump stops working.

4. The Christmas tree foot water replenisher according to claim 1, wherein the first float switch is arranged on a bottom surface of the water storage chamber, the second float switch is arranged on a boss, and the boss is arranged to protrude from the bottom surface of the water storage chamber.

5. The Christmas tree foot water replenisher according to claim 4, wherein the water supply assembly further comprises a water tank assembly, the water tank assembly comprises a water tank main body, the water storage chamber is arranged in the water tank main body, and a cover body further fits the water tank main body;
the cover body is provided with a buckle groove, for buckled with a top wail of the water storage chamber, and a sinking surface arranged downward with respect to the buckle groove, the sinking surface is arranged lower than the buckle groove, and the sinking surface is further provided with an upper hole;
the bottom surface of the water storage chamber is further provided with a precipitation area arranged concavely, and the precipitation area is arranged lower than the bottom surface of the water storage chamber;
a device cavity is arranged under the bottom surface of the water storage chamber, and the water pump and a power supply assembly are arranged in the device cavity;
a motor seat is further arranged in the device cavity, and a motor fixing member is arranged on the side of the motor seat; and
a bottom cover fits the device cavity, and a motor pressing block is arranged on the bottom cover.

6. The Christmas tree foot water replenisher according to claim 1, wherein the water discharge control assembly further comprises a clamp fitted on the tree foot, and the third float switch is connected to the clamp to be located in a vertical position in the cylinder cavity.

7. The Christmas tree foot water replenisher according to claim 6, wherein the water discharge control assembly further comprises a protective cover, the third float switch is arranged in the protective cover, and the protective cover has a cover wall to protect displacement of a floating ball of the third float switch to prevent its floating from interference.

8. The Christmas tree foot water replenisher according to claim 7. wherein the protective cover is formed by fitting two symmetrically arranged protective cover shells, and the interior of the protective cover is hollow to form a float switch cavity for the third float switch to be arranged.

9. The Christmas tree foot water replenisher according to claim 7, wherein the water pipe is sleeved by a wire receiving tube, the wire receiving tube is connected to the protective cover, and a wire of the third float switch is arranged along an outer surface of the water pipe and is received by the wire receiving tube.

10. The Christmas tree foot water replenisher according to claim 9, wherein the clamp comprises a clamp opening for fitting the wire receiving tube, and a first fixing member or second fixing member for connecting; the clamp to the tree foot;
the first fixing member comprises two clamp pieces arranged opposite to each other, so as to be clamped on a wall of the tree foot; and
the second fixing member is used for fitting on a fastener of the tree foot, and comprises a fixed abutting block and a movable adjusting pin rotatably arranged with respect to the fixed abutting block.
